(19) United States
(12) Patent Application Publication
(10) Pub. No.: US 2023/0076041 A1
(43) Pub. Date: Mar. 9, 2023

(54) Method and Apparatus for Remote Interference Detection

(71) Applicant: Telefonaktiebolaget LM Ericsson (publ), Stockholm (SE)

(72) Inventors: Huaisong Zhu, Beijing (CN); Yang Liu, Beijing (CN); Yi Wang, Beijing (CN)

(21) Appl. No.: 17/800,983

(22) PCT Filed: Mar. 6, 2020
(86) PCT No.: PCT/CN2020/078239

§ 371 Date: Aug. 19, 2022

(51) Int. Cl. H04W 72/08

(52) U.S. Cl. CPC H04W 72/082

(57) ABSTRACT

Embodiments of the present disclosure provide methods and apparatus for remote interference detection. A method performed at a first network node may comprise: reporting (S101) an affair that the first network node is interfered; receiving (S102) at least one resource pattern indicating transmission resource allocated by a third network node to the first network node; transmitting (S103) an identifier of the first network node on the transmission resource. The first network node may transmit its identifier in the transmission resource allocated to first network node. Thus, any other network node may particularly try to detect this identifier in the allocated transmission resource. Miss detection or false detection may be reduced accordingly.

### TECHNICAL FIELD

The present disclosure relates generally to the technology of wireless communication, and in particular, to methods and apparatuses for remote interference detection.

### BACKGROUND

This section introduces aspects that may facilitate better understanding of the present disclosure. Accordingly, the statements of this section are to be read in this light and are not to be understood as admissions about what is in the prior art or what is not in the prior art.

In a communication system utilizing Timing Division Duplexing (TDD) technology, e.g. Long Term Evolution (LTE) & New Radio (NR), sometimes Downlink (DL) signals from a remote network node, such as a base station (e.g. eNB/gNB) will travel much longer distance with less attenuation than in usual situation, and therefore will interfere reception of local network node (e.g. a local eNB/gNB) Uplink (UL) signals.

Normally, this phenomenon (also named as Remote Interference, or Remote Intra-Frequency Interference) occurs rarely (several weeks per year), and only in some specific area (like plain area or area near the sea). But once it occurs, it will block the uplink transmission of the local network node. Meanwhile, since too many downlink energy leakages from the remote network node are accumulated in local uplink slot, User Equipment (UE), especially standing at cell middle point or bad point, will fail to access the network. It will seriously impact network performance and reliability.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

To handle such remote interference, one key precondition is to identify interference source. That is, it needs to be detected whether the interference received by the victim eNB/gNB is caused by remote interference of certain remote eNB/gNB or other reasons, e.g. out-of-band emission.

Certain aspects of the present disclosure and their embodiments may provide solutions to these or other challenges. There are, proposed herein, various embodiments which address one or more of the issues disclosed herein. Improved methods and apparatuses for remote interference detection may be provided. Particularly, the possibility of miss detection and/or false detection may be reduced.

A first aspect of the present disclosure provides method performed at a first network node, comprising: reporting an affair that the first network node is interfered; receiving at least one resource pattern indicating transmission resource allocated by a third network node to the first network node; and transmitting an identifier of the first network node on the transmission resource.

In embodiments of the present disclosure, when the resource pattern indicates the transmission resource in terms of time domain, it further indicates a time offset in a periodicity.

In embodiments of the present disclosure, when the resource pattern indicates the transmission resource in terms of frequency domain, it indicates at least one frequency sub-band.

In embodiments of the present disclosure, wherein the at least one resource pattern is selected from a preconfigured group of resource patterns.

In embodiments of the present disclosure, the transmission resource is in a downlink timeslot next to a guarantee period, GP, which is followed by an uplink timeslot in a time division Duplexing, TDD, scheme.

In embodiments of the present disclosure, the method may further comprise: detecting an identifier of a second network node on transmission resource allocated to the second network node, wherein the transmission resource allocated to the second network node is indicated by at least one resource pattern received by the second network node.

In embodiments of the present disclosure, the method may further comprise: sending a detection result of the identifier of the second network node to the third network node.

In embodiments of the present disclosure, wherein whether the first network node is interfered by the second network node is determined based on a detection result of the identifier of the second network node and the at least one resource pattern received by the second network node.

In embodiments of the present disclosure, the detection result comprises at least one of a signal strength, or a Signal to Interference plus Noise Ratio, SINR; and it is determined that the first network node is interfered by the second network node, if the detection result is bigger than a threshold.

In embodiments of the present disclosure, a plurality of resource patterns are allocated to the second network node; and whether the first network node is interfered by the second network node is determined based on a plurality of detection results of the identifier of the second network node corresponding to the plurality of resource patterns allocated to the second network node.

In embodiments of the present disclosure, the second network node reports an affair that the second network node is interfered.

In embodiments of the present disclosure, the identifier of the first network node is a serial number.

In embodiments of the present disclosure, the first network node is a base station; the second network node is a base station; and the third network node is an Operation Administration and Maintenance, OAM, node.

A second aspect of the present disclosure provides a method performed at a third network node, comprising: determining an interference affair based on reports from a plurality of network nodes; allocating to each of the plurality of network nodes, at least one resource pattern indicating transmission resource allocated to the each of the plurality of network nodes. The transmission resource is for the each of the plurality of network nodes to transmit an identifier.

In embodiments of the present disclosure, when the resource pattern indicates the transmission resource in terms of time domain, it further indicates a time offset in a periodicity.

In embodiments of the present disclosure, when the resource pattern indicates the transmission resource in terms of frequency domain, it indicates at least one frequency sub-band.

In embodiments of the present disclosure, the at least one resource pattern is selected from a preconfigured group of resource patterns.

In embodiments of the present disclosure, the transmission resource is in a downlink timeslot next to a guarantee period, GP, which is followed by an uplink timeslot in a time division Duplexing, TDD, scheme.

In embodiments of the present disclosure, the method may further comprises: determining whether a first network node of the plurality network nodes is interfered by a second network node of the plurality of network nodes, based on a detection result of an identifier of the second network node from the first network node.

In embodiments of the present disclosure, the detection result comprises at least one of a signal strength, or a Signal to Interference plus Noise Ratio, SINR; and it is determined that the first network node is interfered by the second network node, if the detection result is bigger than a threshold.

In embodiments of the present disclosure, the third network node allocates a plurality of resource patterns to the second network node; and the third network node determines whether the first network node is interfered by the second network node, based on a plurality of detection results of the identifier of the second network node corresponding to the plurality of resource patterns allocated to the second network node.

In embodiments of the present disclosure, the first network node is a base station; the second network node is a base station; and the third network node is an Operation Administration and Maintenance, OAM, node.

In embodiments of the present disclosure, the identifier is a serial number.

A third aspect of the present disclosure provides a first network node, comprising: a processor; and a memory, the memory containing instructions executable by the processor, whereby the first network node is operative to: report an affair that the first network node is interfered; receive at least one resource pattern indicating transmission resource allocated by a third network node to the first network node; and transmit an identifier of the first network node on the transmission resource.

In embodiments of the present disclosure, the first network node is operative to perform the method according to any of embodiments in the first aspect.

A fourth aspect of the present disclosure provides a third network node, comprising: a processor; and a memory, the memory containing instructions executable by the processor, whereby the third network node is operative to: determine an interference affair based on reports from a plurality of network nodes; allocate to each of the plurality of network nodes, at least one resource pattern indicating transmission resource allocated to the each of the plurality of network nodes. The transmission resource is for the each of the plurality of network nodes to transmit an identifier.

In embodiments of the present disclosure, the third network node is operative to perform the method according to any of embodiments of the second aspect.

A fifth aspect of the present disclosure provides a computer-readable storage medium storing instructions which when executed by at least one processor, cause the at least one processor to perform the method according to any one of embodiments of the first and the second aspects.

A sixth aspect of the present disclosure provides a computer program product comprising instructions which when executed by at least one processor, cause the at least one processor to perform the method according to any of embodiments of the first and the second aspects.

Embodiments herein afford many advantages. For example, in some embodiments herein, the network node may transmit its identifier in the transmission resource allocated to network node. Thus, any other network node may particularly try to detect this identifier in the allocated transmission resource. Miss detection or false detection may be reduced accordingly. A person skilled in the art will recognize additional features and advantages upon reading the following detailed description.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram simplistically illustrating a remote uplink interference;

FIG. 2 is a diagram illustrating an exemplary handling manner for remote uplink interference;

FIG. 3 is an exemplary flowchart of a method performed at a first network node for remote interference detection, according to embodiments of the present disclosure;

FIG. 4 is an exemplary diagram shows time resource configured by a resource pattern, according to embodiments of the present disclosure;

FIG. 5 is a further detailed exemplary diagram shows resource configured by a resource pattern, according to embodiments of the present disclosure;

FIG. 6 is an exemplary flowchart showing further steps of the method performed at the first network node for remote interference detection, according to embodiments of the present disclosure;

FIG. 7 is an exemplary flowchart of a method performed at a third network node for remote interference detection, according to embodiments of the present disclosure;

FIG. 8 is an exemplary flowchart showing further steps of the method performed at the third network node for remote interference detection, according to embodiments of the present disclosure;

FIG. 9 is an exemplary flowchart showing cooperation of different network nodes for remote interference detection, according to embodiments of the present disclosure;

FIG. 10 is a block diagram showing exemplary apparatuses suitable for practicing the network nodes according to embodiments of the disclosure;

FIG. 11 is a block diagram showing an apparatus readable storage medium, according to embodiments of the present disclosure;

FIG. 12 is a schematic showing units for the first network node, according to embodiments of the present disclosure; and

FIG. 13 is a schematic showing units for the third network node, according to embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable wireless communication standards. For example, the wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node” may also refer to any suitable function which can be implemented in a network entity (physical or virtual) of a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP' LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to 5G or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

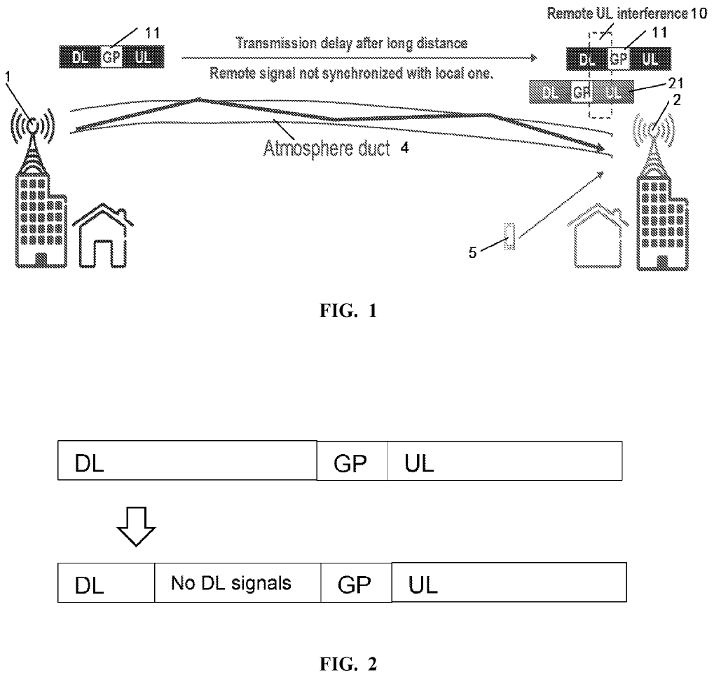

FIG. 1 is a diagram simplistically illustrating a remote uplink interference.

As shown in FIG. 1, signals 11 from a first network node 1 travels through an atmosphere duct 4 to a second network node 2. The signals 11 may include a downlink signal, which is followed by a guarantee period and an uplink signal. After long distance (which causes obvious transmission delay) in the atmosphere duct 4, the signals 11 will not be synchronized with the signals 21 of the second network node 2 anymore. Even more, the downlink signal of signals 11 might interfere with the uplink signal of the signals 21, due to a transmission delay bigger than the guarantee period of the signals 21.

In such a situation, the remote interference happens. Since the signal power of the downlink signal of signals 11 from the first network 1 is usually much bigger than that of any terminal device 5 (such as mobile phone) serving/managed by the second network node 2, the communication from the terminal device 5 may be interfered or even totally blocked, since the second network node 2 could barely “hear” voices from terminal device 5.

Without limitation, the first network node 1 and the second network node 2 may be base stations.

FIG. 2 is a diagram illustrating an exemplary handling manner for remote uplink interference.

After interference source has been identified, there are several exemplary methods to handle the remote interference. 1. The downlink transmission time of the interference source eNB/gNB might be reduced. In other word, it is to make guarantee period between last downlink signal transmission and first uplink signal transmission larger. 2. The interfering eNB/gNB antenna tilt may be increased. 3. The interfering eNB/gNB transmission power may be decreased. Last 2 methods normally work if interfering eNB/gNB is just for capacity extension but its coverage will be considerably shrunk.

As for the first method for decrease the remote interference mentioned above as shown in FIG. 2, the downlink signal of the signals 11 from the first network node 1 may be shortened in time domain, so as to increase the guarantee period between the uplink signal and the downlink signal. That is, the part of the downlink signal of the signals 11, which is possible to interfere the second network node 2, may be muted. Further, due to a reciprocity of the transmission path between the first network node 1 and the second network node 2, the downlink signal of the signal 21 from the second network node 2 may also be shortened in time domain in the same manner.

By shorten time length of downlink signal, the remote interference between the first network node 1 and the second network node 2 may be suppressed. Side effect is that the utilization efficiency of the time resource may be reduced. The longer the guarantee period is extended, the higher possibility of the remote interference be reduced. However, it is known the downlink slot length could not be unlimitedly shortened.

Meanwhile, it can be understood that it is important to find a remote interference aggressor/source for another network node.

As one industrial solution is to use principle of reciprocity. For example, if the interfered network node, such as an eNB/gNB, has detected “abnormal” interference in UL, then this eNB/gNB could also be a remote interference aggressor for another eNB/gNB.

By this principle, each eNB/gNB, who could possibly be a remote interference victim (therefore also an aggressor), will transmit a characteristic sequence in DL simultaneously, and characteristic sequence of each eNB/gNB is unique in a network. And every interfered eNB/gNB will detect characteristic sequence from other candidate aggressor eNB/gNB in UL simultaneously to confirm which eNB/gNB is generating remote interference. By transmitting characteristic sequence in a DL slot close to the guarantee period so as to leave other DL slot for normal data transmission, utilization efficiency of time resource would be impacted as less as possible.

The method is theoretically feasible. However, based on field measurement results, even though remote interference is very strong in total for a victim eNB/gNB, the strength of each remote interference source is too low to be effectively detected, since such interference usually caused by a big mount of aggressor eNB/gNBs.

For example, once remote interference occurs, normally hundreds of eNB/gNB will remotely interfere one eNB/gNB. In other word, for a specific interference source, its interfering power is a small fraction of total remote interference in average and can be barely detected.

Here an example will be illustrated, and this example will be used in following descriptions. It is supposed that: each interfering source will generate 5 dB noise rise, i.e. 5 dB higher than noise; and totally 512 interfering sources exist. Then, the victim will suffer 5 dB +10^{∗}log10 (512) = 25 dB noise rise.

In this case, 25 dB noise rise is a very big problem for uplink coverage. Take typical sub-urban cell as example, 25 dB noise rise will make cell coverage shrink to 20% of no-interference case, or in worst case 80% UEs suffer call drop or can’t access the network.

In an exemplary implementation, each source will be allocated with a unique sequence and transmit such unique sequence simultaneously. To detect any specific interfering source, victim received (Signal to Interference plus Noise Ratio) SINR of corresponding sequence is: SINR = -10^{∗}log10 (512) = -17 dB.

It will be very hard for a receiver to guarantee detection success rate for this extreme low SINR and which in fact will introduce 2 drawbacks in implementation. 1. Miss detection: some of interfering sources will be neglect by victim base station. 2. False detection: since victim tries to detect such low SINR signal, victim receiver will be very sensitive to noise signal ripple, and it will detect a lot of ‘fake’ signal that not exist.

Accordingly, as miss detection victim, it will miss a lot of real interfering eNB/gNB, which eventually not resolve remote interference problem. As false detected not-interfering eNB/gNB, it will make not-interfering eNB waste the downlink transmission time but no gain to victim eNB/gNB.

This will cause serious remote interference detection performance degradation. For example, some operator find remote interference issue is not well-handle even switching-on remote interference detection and handling features.

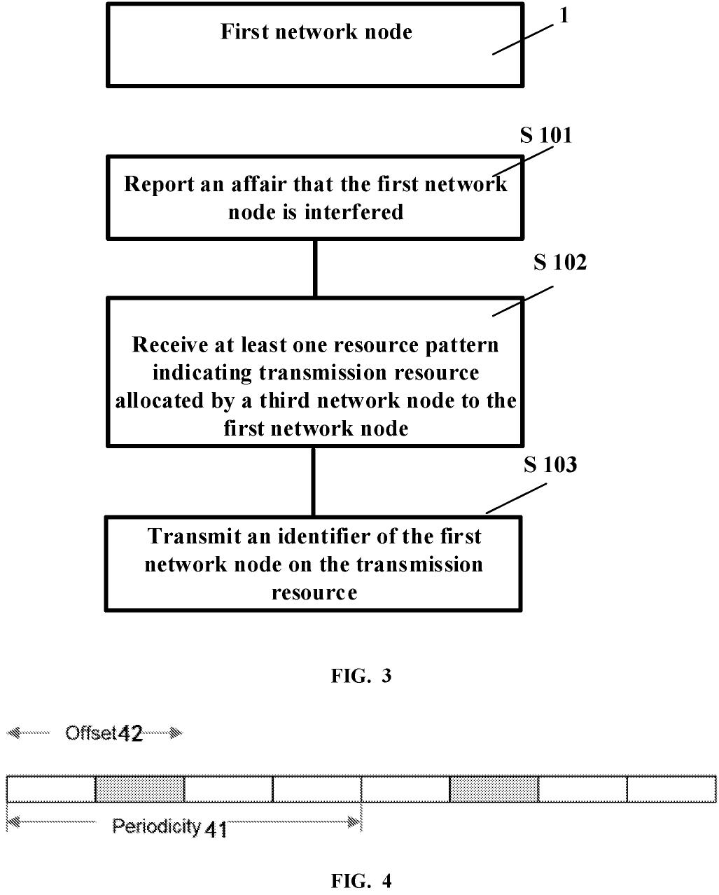

FIG. 3 is an exemplary flowchart of a method performed at a first network node for remote interference detection, according to embodiments of the present disclosure.

As shown in FIG. 3, the method performed at a first network node 1 may comprise: S101, reporting an affair that the first network node is interfered; S102, receiving at least one resource pattern indicating transmission resource allocated by a third network node to the first network node; and S103, transmitting an identifier of the first network node on the transmission resource.

Compared to make all suspect interfering network node (such as eNB/gNB) transmit identifier (such as characteristic sequence) simultaneously, a resource pattern is assigned to the network node for transmission. Such pattern may indicates a specific transmission resource with at least one of: time, or frequency of the transmission resource.

According to embodiments of the present disclosure, each gNB/eNB is assigned with one or multiple resource pattern for remote interference detection and assigned a cell specific characteristic sequence. Accordingly, in the same transmission resource, the number of the network nodes transmitting different identifiers are reduced, or even limited to only one. Alternatively, the assigned cell specific characteristic sequence would be substituted by the unique cell identifier (ID) deployed in the network system.

Therefore, by dividing candidate cells into multiple resource pattern, it can at least partially avoid too noisy issue during remote interference detection. The possibility of miss detection and/or false detection may be reduced.

FIG. 4 is an exemplary diagram shows time resource configured by a resource pattern, according to embodiments of the present disclosure.

In embodiments of the present disclosure, when the resource pattern indicates the transmission resource in terms of time domain, it further indicates a time offset in a periodicity.

In embodiments of the present disclosure, when the resource pattern indicates the transmission resource in terms of frequency domain, it indicates at least one frequency sub-band.

Namely, the pattern may particularly indicates a specific periodical transmission resource, which includes: period, time offset in period, frequency resource, or etc.

For example, resource pattern may particularly means that in a specific downlink timeslot within a fixed period (time-division) and/or a specific frequency sub-band (frequency-division), eNB/gNB shall transmit a specific characteristic sequence in its allocated resource pattern(s). A resource pattern can be allocated to one or multiple cells, and in another aspect, a cell is assigned to one pattern or multiple resource patterns.

Taking Time-division mode as example for illustration, a third network node (such as Operation Administration and Maintenance, OAM) will assign each cell (base station) one or several specific periodical time instance(s) to send out characteristic sequence. And applicable time instance is a slot just ahead of downlink (DL) to uplink (UL) switch point.

As shown in FIG. 4, LTE TDD configuration 2 is further taken as an example. In every 5 ms, there will be a switch point (DL to UL), which is a possible time instance for sending out characteristic sequence. In this example, OAM can assign 20 ms as periodicity 41, there will be 4 (20 ms/5 ms) candidate time instances. In this example, OAM will assign offset 42 equal to “2” for this specific (set of) eNB (s).

FIG. 4 shows an example with the same offset in different periodicity. However, the offset may vary in different periodicity so as to improve the variety of the patterns.

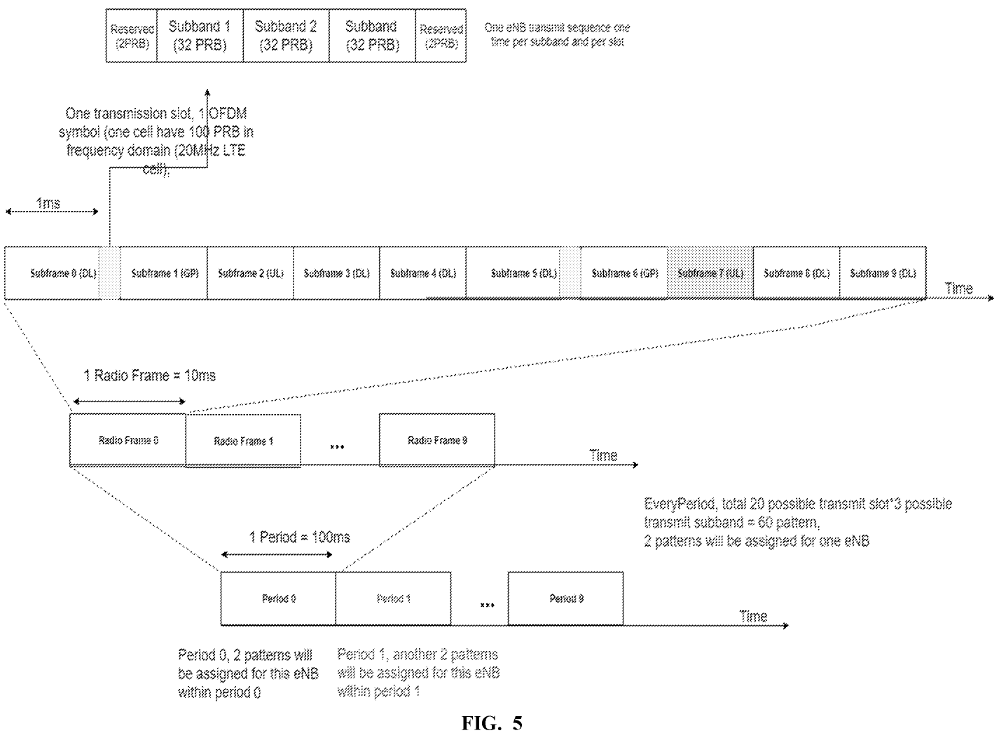

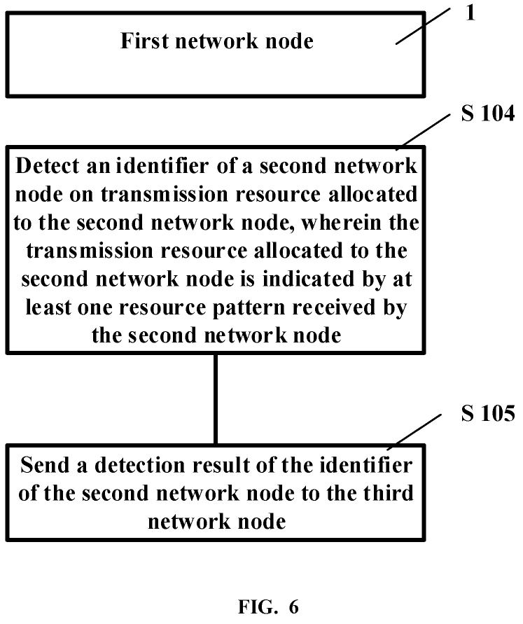

FIG. 5 is a further detailed exemplary diagram shows resource configured by a resource pattern, according to embodiments of the present disclosure.

As shown in FIG. 5, the time line of one detection duration may be detailed from bottom to top. For example, the detection duration may comprise a plurality of periods.

One period may be equal to 100 ms, and comprise 10 radio frames. One Radio frame may be equal to 10 ms, and comprise 10 subframes. Each subframe (1 ms) may comprise 2 transmit slot. Each transmit slot may comprise a plurality of OFDM symbols, such as 7 OFDM symbols. Particularly, in a LTE cell with 20 MHz, one ell may have 100 physical resource block, PRB, in frequency domain, to any part of which patterns could be corresponded. As an example shown in FIG. 5, in those 100 PRBs, 2 PRB in the start and 2 PRB in the end are reserved. Then 32 PRB are configured in each of the subband 1, subband 2 and subband 3.

In embodiments of the present disclosure, the frequency of the transmission resource comprises at least one frequency sub-band, such as any of the above subband 1, subband 2 and subband 3.

In embodiments of the present disclosure, the at least one resource pattern is selected from a preconfigured group of resource patterns.

For example, in every period, assuming one transmit slot with one transmit subband is necessary for transmitting the identifier once, then there are 20 possible transmit slot * 3 possible transmit subband = 60 pattern, wherein one subband is ⅓ of the bandwidth. Further, in one detection duration with 10 periods (periods 0 to period 9), there are total 200 possible transmit slot * 3 possible transmit subband = 600 patterns, as the preconfigured group of resource patterns. It should be understood the number of the periods is also not limited. For example, in one situation, only one period may be utilized for quicker detection, while in another situation, more than one period may be utilized for more accurate detection.

As an example in FIGS. 5, 20 patterns may be assigned for one eNB in one period. One eNB may transmit identifier (characteristic sequence) one time per subband and per slot. Each period can be configured individually. That is, in period 0, 2 patterns will be assigned for one eNB. Then in period 1, another 2 patterns will be assigned for the same eNB. When the parameters of frame number, subframe number, and/or subband number are used to represent the patterns, it should be understood that, the another 2 patterns in period 1 may or may not have the same frame number and/or the same subframe number and/or the same subband number with the 2 patterns in period 0. When such parameters vary according to periods, it is less possible for different eNB to always have the same patterns (i.e. parameters). Thus, the detection possibility will be further improved.

In embodiments of the present disclosure, the at least one resource pattern may be randomly selected from a preconfigured group of resource patterns.

The patterns for different eNBs may be not overlapped, if the number of the eNBs is not very large. When the amount of impacted eNBs becomes larger, if an eNB is allocated to only one pattern, the possibility of overlapping pattern between two eNBs will increase. Therefore, to allocate more than one recourse patterns to an eNB can reduce the possibility of fully overlapping on the patterns. According to the example illustrated in FIG. 5, in each period, 20 patterns may be randomly (or, pseudo-randomly) selected from the 600 patterns for one eNB. As a result, even if the patterns for different eNBs are partly overlapped, the burden for detecting different identifiers in the same transmission resource still can be greatly reduced. Further, due to the random assignment, the overlap in different period will vary. Thus at least in some periods, a reliable detection may be possible due to a non-overlap or slight overlap situation.

Further, some basic principles may be established during the selection to allocate minimal number of victim eNB/gNB with same pattern. A preferable solution is round-robin allocation.

As one example, there are 8 candidate patterns allocated with time domain (periodicity is 40 ms), 8 candidate frequency domain patterns (one time-instance can utilize only ⅛ bandwidth (as one subband) for this pattern), besides a channel combination manner of “Comb-4” may be selected. So, in total 8*8*4=256 time and frequency patterns are to be selected as candidates.

Take the above example, 512 eNBs report possible remote interference, and each eNB assign 4 patterns, then every 8 eNBs will share one pattern, i.e. max 8 eNB transmit different sequence simultaneously:

Then every victim eNB will detect:

min SINR = -10^{∗}log10 (interfering number-1) = -10^{∗}log10(7) = -8.4 dB; in case all 8 eNB are interfering eNB.

To detect a sequence with in worst case -8.4 dB SINR (which is much better than -17 dB without pattern above described), eNB/gNB can reach much better low false detection rate and miss detection rate.

And by multiple patterns for each node, eNB/gNB can further improve false detection rate and miss detection rate.

In embodiments of the present disclosure, the transmission resource is in a downlink timeslot next to a guarantee period, GP, which is followed by an uplink timeslot in a time division Duplexing, TDD, scheme.

In embodiments of the present disclosure, the transmission resource is located in at least one OFDM symbol in the downlink timeslot.

In embodiments of the present disclosure, the transmission resource is located in a sub-band of the downlink timeslot.

As shown in FIG. 5, the subframes may be configured for either UL, GP, or DL. In embodiments of the present disclosure, one transmission slot may be particularly allocated in the subframe for DL, followed by the GP and UL.

It should be understood, the transmission resource indicated by a pattern is not limited as above. Due to the content of the identifier (e.g. characteristic sequence), there may be more than one OFDM symbol (or even more than one slots), and/or more than one sub band (or less of them) to be assigned as one pattern.

The characteristic sequences may be statically or dynamically configured for each of the network node. Such characteristic sequences may be specifically generated for the interference detection, or just reuse existing parameters.

In embodiments of the present disclosure, the identifier of the first network node may be a serial number of the first network node itself.

In embodiments of the present disclosure, the first network node may be victims reporting an interference.

As described above, the first network 1, which is assigned with resource patterns to transmit an identifier, is considered a potential interference source. However, before a detection and determination procedure, it is hard to practically confirm which network node is interference source or not. Therefore, due to a reciprocity of the remote interference, the network node reporting an interference is considered as a potential interference resource for another network node.

FIG. 6 is an exemplary flowchart showing further steps of the method performed at the first network node for remote interference detection, according to embodiments of the present disclosure.

As shown in FIG. 6, the method may further comprise: S104, detecting an identifier of a second network node on transmission resource allocated to the second network node, wherein the transmission resource allocated to the second network node is indicated by at least one resource pattern received by the second network node.

In embodiments of the present disclosure, the method may further comprise: S105, sending a detection result of the identifier of the second network node to the third network node.

While the network nodes (which are considered as both victim and potential aggressor of the remote interference) transmit identifiers, they are also detecting identifiers from other network nodes.

In embodiments of the present disclosure, wherein whether the first network node is interfered by the second network node is determined based on a detection result of the identifier of the second network node and the at least one resource pattern received by the second network node.

As a receiver, the network node may specifically utilize energy-based sequence detection, and try to distinguish signal from noise after matched filter. The detection result may comprise any instructive parameters generated by the filter or any other algorithm. For example, a power level of the signal, or SINR, or any further parameter calculated based on the power level or SINR.

In embodiments of the present disclosure, the detection result comprises at least one of a signal strength, or a Signal to Interference plus Noise Ratio, SINR; and it is determined that the first network node is interfered by the second network node, if the detection result is bigger than a threshold.

In embodiments of the present disclosure, it is determined that the first network node is not interfered by the second network node, if the detection result is less than the threshold.

In embodiments of the present disclosure, the second network node is another victim reporting an interference.

As one example, the receiver may give a decision “Interfered”, or “Not interfered”, directly based on detection result and locally preconfigured threshold. However, some vague signals might be hard to be distinguished as interference or not.

In embodiments of the present disclosure, a plurality of resource patterns are allocated to the second network node; and whether the first network node is interfered by the second network node is determined based on a plurality of detection results of the identifier of the second network node corresponding to the plurality of resource patterns allocated to the second network node.

For example, the receiver may firstly calculate detection possibility corresponding to any of the plurality of patterns instead of a hard decision, which avoid headache balance between miss detection and false detection. Then, the detection possibilities will be further compared with a global threshold.

As one example method about how to calculate possibility, receiver can estimate the SINR (suppose there is a signal) by matched filter, then normalize the SINR with local thresholds to a detection possibility:

If SINR > threshold_high, Possibility = 1, which means detection result SINR is larger than a certain threshold, gNB/eNB can confirm there is an interfering sequence;

If SINR < threshold_low, Possibility = 0, which means detection result SINR is low than a certain threshold, gNB/eNB can confirm there is no interfering sequence;

For threshold_high >= SINR >= threshold_low,

possibility = [SINR- threshold_low]/[threshold_high - threshold_low]; which means it needs to be further confirmed whether there is an interference or not.

A plurality of determination result possibilities corresponding to the plurality of resource patterns allocated to the second network node may be then compared with a threshold.

That is, a kind of voting based method can be used to judge whether a gNB/eNB is an interfering source, based on a plurality of detection results/possibility for the same potential aggressor network node. 2 examples are listed below:

1. Max (possibility) of the plurality of detection results > a first global threshold. For example, from detection result in 4 resource patterns (by one or more receivers) for the same potential aggressor, the interference will be confirmed when the max possibility > 0.8;

2. Mean (possibility) of the plurality of detection results > a second global threshold, for example, from detection result in 4 resource patterns (by one or more receivers) for the same potential aggressor, the interference will be confirmed, when the mean possibility > 0.5;

Another dimension of voting is to vote on gNB/eNB level from multiple cell belongs to the same gNB/eNB node. Each cell will have its own measurement and voting based method can combine multiple cell result to judge whether gNB/eNB is an interfering source.

The network nodes may cooperate with each other to exchange such plurality of detection results. Further, the third network node, such as Operation Administration and Maintenance, OAM, may manage and coordinate these network nodes to finish such detection and determination procedure.

In embodiments of the present disclosure, a final determination result, global threshold, etc. will be determined by an Operation Administration and Maintenance, OAM.

According to embodiments of the present disclosure, victim network node will give judgment on whether there is interference from one source network node, based on multiple detection results for the same one source network node, so as to further reduce risk of miss detection and false detection possibility. These multiple detection results may be from a plurality of patterns for the source network node, detected by one or more receivers.

That is, even in case of multiple interfering nodes, the remote interference source can still be effectively and reliably detect.

Then, if network nodes (or usually pairs of network nodes) are confirmed as aggressors, the downlink transmission time of them may be reduced, and/or antenna tilt of them may be increased, and/or transmission power of them may be reduced.

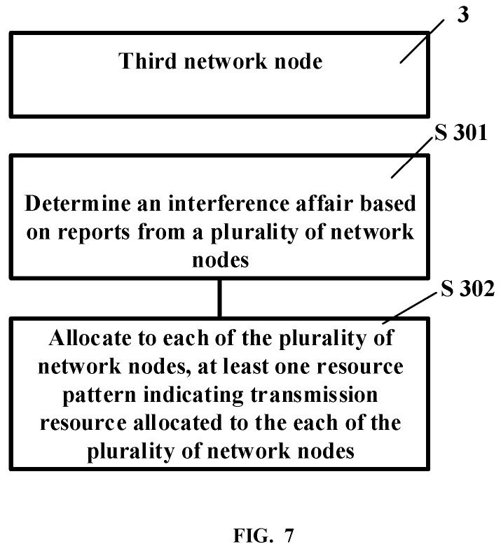

FIG. 7 is an exemplary flowchart of a method performed at a third network node for remote interference detection, according to embodiments of the present disclosure.

As shown in FIG. 7, the method performed at the third network node 3 comprise: S301, determining an interference affair based on reports from a plurality of network nodes; S302, allocating to each of the plurality of network nodes, at least one resource pattern indicating transmission resource allocated to the each of the plurality of network nodes. The transmission resource is for the each of the plurality of network nodes to transmit an identifier.

In embodiments of the present disclosure, when the resource pattern indicates the transmission resource in terms of time domain, it further indicates a time offset in a periodicity.

In embodiments of the present disclosure, when the resource pattern indicates the transmission resource in terms of frequency domain, it indicates at least one frequency sub-band.

In embodiments of the present disclosure, the at least one resource pattern is selected from a preconfigured group of resource patterns.

In embodiments of the present disclosure, the transmission resource is in a downlink timeslot next to a guarantee period, GP, which is followed by an uplink timeslot in a time division Duplexing, TDD, scheme.

In embodiments of the present disclosure, the identifier is a serial number.

According to the embodiments of the present disclosure, each of the plurality of network nodes may transmit its identifier in the transmission resource allocated to each of the plurality of network nodes by the third network node 3. Thus, any other network node may particularly try to detect this identifier of on the allocated transmission resource. Miss detection or false detection may be reduced accordingly.

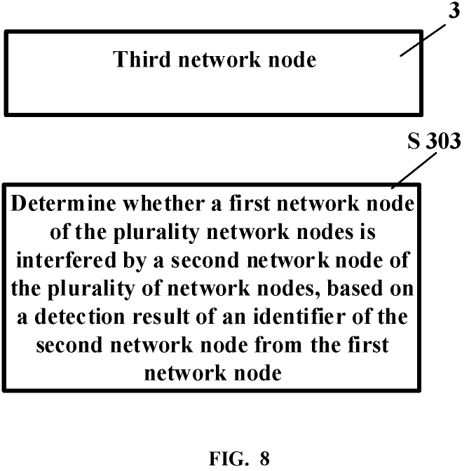

FIG. 8 is an exemplary flowchart showing further steps of the method performed at the third network node for remote interference detection, according to embodiments of the present disclosure.

As shown in FIG. 8, the method may further comprise: S303, determining whether a first network node of the plurality network nodes is interfered by a second network node of the plurality of network nodes, based on a detection result of an identifier of the second network node from the first network node.

In embodiments of the present disclosure, the detection result comprises at least one of a signal strength, or a Signal to Interference plus Noise Ratio, SINR; and it is determined that the first network node is interfered by the second network node, if the detection result is bigger than a threshold.

In embodiments of the present disclosure, the third network node allocates a plurality of resource patterns to the second network node; and the third network node determines whether the first network node is interfered by the second network node, based on a plurality of detection results of the identifier of the second network node corresponding to the plurality of resource patterns allocated to the second network node.

In embodiments of the present disclosure, the first network node is a base station; the second network node is a base station; and the third network node is an Operation Administration and Maintenance, OAM, node.

According to embodiments of the present disclosure, the third network node 3 will give judgment on whether there is interference from one source network node to a victim network node, based on multiple detection results for the same one source network node, so as to further reduce risk of miss detection and false detection possibility. These multiple detection results may respectively correspond to the plurality of patterns for the source network node, detected by one or more receivers.

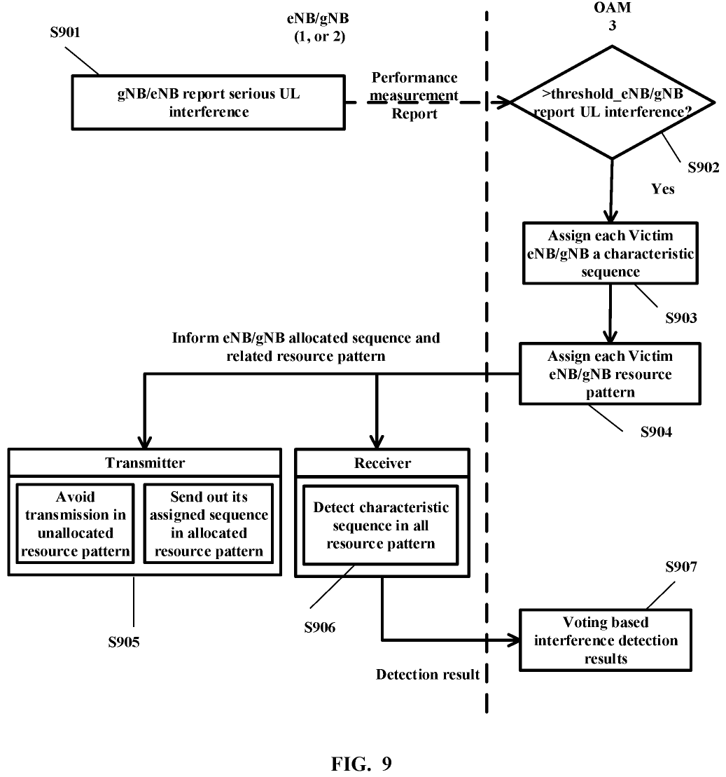

FIG. 9 is an exemplary flowchart showing cooperation of different network nodes for remote interference detection, according to embodiments of the present disclosure.

As shown in the FIG. 9, in step S901, an eNB/gNB (i.e. the above first network node 1 and/or second network node 2) reports serious UL interference to OAM (i.e. the above third network node 3) through performance measurement report.

For example, gNB/eNB will periodically report whether it received constant uplink interference or not to OAM system throughput PM (performance Monitor) functions to OAM system.

In step S902, the OAM determines whether there is remote interference.

For example, once OAM received constant strong uplink interference reports from eNB/gNB, it will consider whether there are a large percentage (larger than a threshold_eNB/gNB) of eNB/gNB report similar report within an area, e.g. in one province, 10% or 20% of gNB/eNB report uplink interference issue. If yes, OAM suspect remote interference issue and take actions to confirm this suspect. That is, the step S903 will be triggered.

In step S903, OAM should assign a characteristic sequence to one cell, and this sequence is unique within the whole OAM system. Alternatively, unique Cell ID can be sent instead of assigning a sequence specific for the interference detection.

In step S903, OAM assign each victim eNB/gNB resource pattern. The resource pattern indicates a specific downlink timeslot within a specific period (time-division) and/or a specific frequency sub-band (frequency-division). The eNB/gNB shall transmit a specific characteristic sequence in its allocated resource pattern(s). Alternatively, the resource patterns can be allocated to eNB/gNBs in advance and triggered when OAM determined that a remote interference affair occurs. And OAM can change to another batch of resource patterns for an update.

Pattern can be allocated to one or multiple cells associating to the eNB/gNB. Additionally or alternatively, one cell can have one pattern or multiple patterns.

For example, OAM will assign each cell one or several specific periodical time instance(s) to send out characteristic sequence. And applicable time instance is slot just before DL to UL switch point.

Further, OAM will assign a specific subband for this eNB/gNB to send out characteristic sequence.

Frequency-division mode can be also applied for Comb, which means one pattern maps to odd-subcarrier number and another pattern maps to even-subcarrier number (i.e. Comb-2). Of course, there are other comb modes, like one subcarrier for every adjacent 4 subcarriers (i.e. Comb-4). For example, when a Comb-4 manner is used for a situation with 12 subcarriers (1-12), there may be four combination about the subcarriers, A: subcarrier 1,5,9; B:subcarrier 2,6,10; C: subcarrier 3,7,11; D: subcarrier 4,8,12. Then, even the parameters (such as frame number, subframe number, etc.) in the time domain are the same, there will be four patterns according to different combinations of subcarriers.

OAM will allocate victim eNB/gNB with one/multiple specific pattern.

Then, in step S905, the transmitter of any eNB/gNB will avoid transmission in unallocated resource pattern, and send out its assigned sequence in allocated resource pattern. In step S906, the receiver of any eNB/gNB will detect characteristic sequence in all resource pattern.

The detection result from multiple eNB/gNB on multiple patterns will be transmitted to the OAM.

In step S907, the OAM will generate interference detection results based on voting.

Multiple pattern to one cell associating with eNB/gNB may provide certain improvements. Purpose of multiple pattern is to determine whether a suspect gNB/eNB is really an interfering gNB/eNB based on multiple perspective, i.e. voting by the result from each pattern.

For example, OAM has detected 512 suspects eNB/gNB, which need to be further distinguished. One possible solution to determine whether a suspect is really an interfering gNB/eNB or not is that OAM will randomly assign 4 different patterns to one suspect. If victim said this eNB is interfering eNB based on detecting result on all these 4 patterns, then OAM is very confident to determine this eNB as interfering eNB and execute all follow-up remote interference handling procedure.

But if only results on 2 pattern says this eNB is interfering eNB, OAM should set more pattern to this eNB or just ignore this eNB (since in this case, uncertainty mainly comes from weak interference, ignore this possible remote interference source will not introduce too much drawbacks).

Thus, by pattern allocation, interference from remote aggressor will be distributed in different time/frequency, and quite easily to be detected. Also, through voting mechanism, transmission in multiple patterns will further improve detection accuracy.

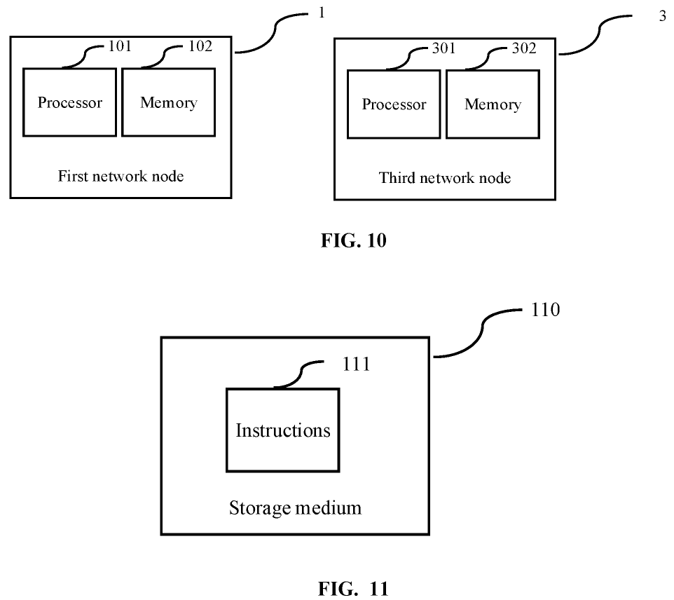

FIG. 10 is a block diagram showing exemplary apparatuses suitable for practicing the network nodes according to embodiments of the disclosure;

As shown in FIG. 10, the first network node 1 may comprise: a processor 101; and a memory 102, the memory 102 containing instructions executable by the processor, whereby the first network node 1 is operative to: report an affair that the first network node is interfered; receive at least one resource pattern indicating transmission resource allocated by a third network node to the first network node; and transmit an identifier of the first network node on the transmission resource.

In embodiments of the present disclosure, the first network node 1 is operative to perform the method according to any of the above embodiments, such as these shown in FIGS. 3 to 6, 9.

As shown in FIG. 10, the third network node 3 may comprise: a processor 301; and a memory 302, the memory containing instructions executable by the processor 301, whereby the third network node 3 is operative to: determine an interference affair based on reports from a plurality of network nodes; allocate to each of the plurality of network nodes, at least one resource pattern indicating transmission resource allocated to the each of the plurality of network nodes. The transmission resource is for the each of the plurality of network nodes to transmit an identifier.

In embodiments of the present disclosure, the third network node is operative to perform the method according to any of the above embodiments, such as those shown in FIGS. 7 to 9.

The processors 101, 301 may be any kind of processing component, such as one or more microprocessor or microcontrollers, as well as other digital hardware, which may include digital signal processors (DSPs), special-purpose digital logic, and the like. The memories 102, 302 may be any kind of storage component, such as read-only memory (ROM), random-access memory, cache memory, flash memory devices, optical storage devices, etc.

FIG. 11 is a block diagram showing an apparatus readable storage medium, according to embodiments of the present disclosure.

As shown in FIG. 11, the computer-readable storage medium 110, or any other kind of product, storing instructions 111 which when executed by at least one processor, cause the at least one processor to perform the method according to any one of the above embodiments, such as these shown in FIGS. 3-9.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

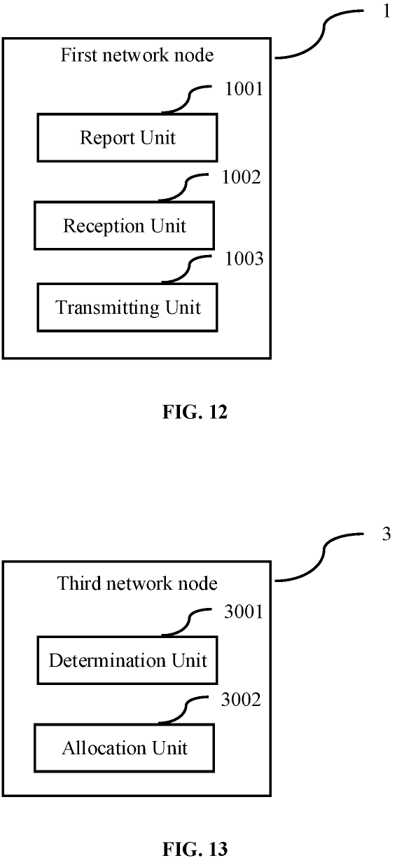

FIG. 12 is a schematic showing units for the first network node, according to embodiments of the present disclosure.

As shown in FIG. 12, the first network node 1 may comprise: a report unit, configured to report an affair that the first network node is interfered; a reception unit 1002, configured to receive at least one resource pattern indicating transmission resource allocated by a third network node to the first network node; and a transmission unit 1003, configured to transmit an identifier of the first network node on the transmission resource

In embodiments of the present disclosure, the first network node 1 is operative to perform the method according to any of the above embodiments, such as these shown in FIGS. 3 to 6, 9.

FIG. 13 is a schematic showing units for the third network node, according to embodiments of the present disclosure.

As shown in FIG. 13, the third network node 3 may comprise: a determination unit, configured to determine an interference affair based on reports from a plurality of network nodes; and an allocation unit 3002, configured to allocate to each of the plurality of network nodes, at least one resource pattern indicating transmission resource allocated to the each of the plurality of network nodes. The transmission resource is for the each of the plurality of network nodes to transmit an identifier.

In embodiments of the present disclosure, the third network node 3 is operative to perform the method according to any of the above embodiments, such as those shown in FIGS. 7 to 9.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With these units, the network node 100, may not need a fixed processor or memory, any computing resource and storage resource may be arranged from at least one network node/device/entity/apparatus relating to the communication system. The virtualization technology and network computing technology (e.g. cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-25. (canceled)

26. A method performed at a first network node, comprising:
reporting an affair that the first network node is interfered;
receiving a resource pattern indicating transmission resource allocated by a third network node to the first network node; and
transmitting an identifier of the first network node on the transmission resource.

27. The method of claim 26, wherein the resource pattern:
to indicate the transmission resource in terms of time domain, further indicates a time offset in a periodicity; and/or
to indicate the transmission resource in terms of frequency domain, further indicates at least one frequency sub-band; and/or
is selected from a preconfigured group of resource patterns.

28. The method of claim 26, wherein the transmission resource is in a downlink timeslot next to a guarantee period, which is followed by an uplink timeslot in a time division duplexing scheme.

29. The method of claim 26, further comprising:
detecting an identifier of a second network node on transmission resource allocated to the second network node, wherein the transmission resource allocated to the second network node is indicated by at least one resource pattern received by the second network node; and
sending a detection result of the identifier of the second network node to the third network node.

30. The method of claim 29, further comprising determining whether the first network node is interfered by the second network node based on:
the at least one resource pattern received by the second network node; and
the detection result being bigger than a threshold;
wherein the detection result comprises a signal strength and/or Signal to Interference plus Noise Ratio (SINR).

31. The method of claim 30, wherein:
a plurality of resource patterns are allocated to the second network node; and
whether the first network node is interfered by the second network node is determined based on a plurality of detection results of the identifier of the second network node corresponding to the plurality of resource patterns allocated to the second network node.

32. The method of claim 29, wherein:
the first network node and second network node are base stations; and
the third network node is an Operation Administration and Maintenance (OAM) node.

33. A method performed at a third network node, the method comprising:
determining an interference affair based on reports from a plurality of network nodes; and
allocating, to each of the plurality of network nodes, a resource pattern indicating transmission resource allocated to the network node;
wherein the transmission resource is for the corresponding network node to transmit an identifier.

34. The method of claim 33, wherein the resource pattern:
to indicate the transmission resource in terms of time domain, indicates a time offset in a periodicity; and/or
to indicate the transmission resource in terms of frequency domain, further indicates at least one frequency sub-band; and/or
is selected from a preconfigured group of resource patterns.

35. The method of claim 33, wherein the transmission resource is in a downlink timeslot next to a guarantee period, which is followed by an uplink timeslot in a time division duplexing scheme.

36. The method of claim 33, further comprising:
determining whether a first network node of a plurality of network nodes is interfered by a second network node of the plurality of network nodes based on whether a detection result of an identifier of the second network node from the first network node is bigger than a threshold;
wherein the detection result comprises a signal strength and/or a Signal to Interference plus Noise Ratio (SINR).

37. The method of claim 36, wherein:
the third network node allocates a plurality of resource patterns to the second network node;and
the third network node determines whether the first network node is interfered by the second network node based on a plurality of detection results of the identifier of the second network node corresponding to the plurality of resource patterns allocated to the second network node.

38. The method of claim 36, wherein:
the first network node and the second network node are base stations; and
the third network node is an Operation Administration and Maintenance (OAM) node.

39. A first network node, comprising:
a processor; and
a memory, the memory containing instructions executable by the processor, whereby the first network node is configured to:
report an affair that the first network node is interfered;
receive a resource pattern indicating transmission resource allocated by a third network node to the first network node; and
transmit an identifier of the first network node on the transmission resource.

40. The first network node of claim 39, wherein the resource pattern:
to indicate the transmission resource in terms of time domain, further indicates a time offset in a periodicity; and/or
to indicate the transmission resource in terms of frequency domain, further indicates at least one frequency sub-band; and/or
is selected from a preconfigured group of resource patterns.

41. The first network node of claim 39, wherein the transmission resource is in a downlink timeslot next to a guarantee period, which is followed by an uplink timeslot in a time division duplexing scheme.

42. The first network node of claim 39, wherein the first network node is further configured to:
detect an identifier of a second network node on transmission resource allocated to the second network node, wherein the transmission resource allocated to the second network node is indicated by at least one resource pattern received by the second network node; and
send a detection result of the identifier of the second network node to the third network node.

43. A third network node, comprising:
a processor; and
a memory, the memory containing instructions executable by the processor, whereby the third network node is configured to:
determine an interference affair based on reports from a plurality of network nodes; and
allocate, to each of the plurality of network nodes, a resource pattern indicating transmission resource allocated to the network node;
wherein the transmission resource is for the corresponding network node to transmit an identifier.

44. The third network node of claim 43, wherein the resource pattern:
to indicate the transmission resource in terms of time domain, indicates a time offset in a periodicity; and/or
to indicate the transmission resource in terms of frequency domain, further indicates at least one frequency sub-band; and/or
is selected from a preconfigured group of resource patterns.

45. The third network node of claim 43, wherein the third network node is further configured to:
determine whether a first network node of a plurality of network nodes is interfered by a second network node of the plurality of network nodes based on whether a detection result of an identifier of the second network node from the first network node is bigger than a threshold;
wherein the detection result comprises a signal strength and/or a Signal to Interference plus Noise Ratio (SINR).
